(19) United States
(12) Patent Application Publication
(10) Pub. No.: US 2010/0013736 A1
(43) Pub. Date: Jan. 21, 2010

(54) DUAL-BAND ANTENNA

(76) Inventor: HARRY K. OGAWA, Surrey (CA)

Correspondence Address: LEONG C LEI, PMB # 1008, 1867 YGNACIO VALLEY ROAD, WALNUT CREEK, CA, 94598, US

(21) Appl. No.: 12/503,093

(22) Filed: Jul. 15, 2009

(30) Foreign Application Priority Data
Jul. 16, 2008 (TW) 097212747

(51) Int. Cl. H01Q 1/36

(52) U.S. Cl. 343/895

(57) ABSTRACT

A structure of a dual-band antenna serves as an antenna for use with a mobile communication device and is operable with radio frequency signals in two different bands, and features low costs and small product size. The antenna includes a first radiating element, a circuit board, and a coaxial feed. The first radiating element is a long helical conductor for operation in a first one of the bands. The circuit board is arranged inside the helical conductor of the first radiating element and includes a second radiating element operable in a second one of the bands.

### TECHNICAL FIELD OF THE INVENTION

The present invention generally relates to a structure of a dual-band antenna, and particularly to an integrated antenna structure that is operable in two frequency bands including at least a band for global positioning system (GPS) and another band for radio frequency band of a very high frequency (VHF) band, or an ultra-high frequency (UHF) band or a low-band VHF band so as to provide a dual-band antenna for use with for example a two-way radio or a pager.

### DESCRIPTION OF THE PRIOR ART

Dual-band antennas are available in the market or are publicly known. An example of the known dual-band antenna is disclosed in U.S. Pat. No. 7,202,836, entitled “Antenna Apparatus and Method of Forming Same”, and which provides a dual-band antenna 100, illustrated in FIG. 1 of the attached drawings. The dual-band antenna 100 generally comprises a single conductor helix 104 having a lower end at which a single feed 102. The conductor helix 104 comprises three sections 108, 110, 112, wherein the conductor helix of the first section 108 is operated for the GPS band. The combined conductor helix of the three sections 108, 110, 112 serves to provide another band (which is often of a low frequency, such as UHF).

Such a known structure of antenna is operable in both the GPS band and another, low-frequency band. However, a disadvantage of such a known antenna is that in a practical application, the input impedance in the GPS band is not close enough to 50 ohms (as demonstrated in FIG. 2 of the attached drawings). FIG. 2 illustrates a Smith Chart centered at 50 ohms. The known dual-band antenna shows the input impedance thereof for the GPS band is far away from the center (50 ohms) and is instead at the location indicated by reference numeral 21 in the drawing. Thus, it does not meet the requirement of having impedance of the GPS band close to 50 ohms, making the performance thereof deteriorated.

Another known, market-available dual-band antenna structure is illustrated in a schematic view shown in FIG. 3, comprising:

a short straight metal lead 31 for the GPS band and a long helical conductive line 32 for another frequency band (which is often of a relative low frequency, such as VHF); and

a single feed provided at a bottom of the dual-band structure.

This known antenna structure shares the same problem with the antenna of U.S. Pat. No. 7,202,836, namely the input impedance of the GPS band does not meet the required 50 ohms.

Further referring to FIG. 4, which illustrates a representative drawing of U.S. Pat. No. 6,229,488, which provides an antenna for receiving signals from GPS and GSM, having a structure comprising:

a patch antenna 52 provided on a circumferential surface of a cylindrical body 40 made of a dielectric material and operative for GPS band and a feeding pin 44 fit at the center of the cylindrical body 40 and having a top end attached to a helical conductor 45 operative for another frequency band; and

bottoms of the patch antenna 52 and the helical conductor 45 being respectively connected to two terminals of a coaxial feed means 501 or a parallel feed means 502 as illustrated in FIG. 5A or FIG. 5B.

There is another disadvantage with the above structure, wherein the dielectric material that makes the cylindrical body 40 serving as the base is of a high cost, if it is made of ceramics. This increases the costs and expenses. If polymer materials are used, then the overall size is increased.

### SUMMARY OF THE INVENTION

In view of the problems of the known dual-band antennas, which are either not meeting the requirement of having input impedance close to 50 ohms or increasing the manufacturing costs and product sizes, the present inventor, based on years' experience of manufacturing and design in the field, provides a novel structure of a dual-band antenna.

An objective of the present invention is thus to provide a structure of a dual-band antenna, which features an input impedance of around 50 ohms and reduces manufacturing costs and product sizes.

To achieve the above objective, in accordance with the present invention, a structure of a dual-band antenna generally comprises a first radiating element, a circuit board, and a coaxial feed. The first radiating element comprises a long helical conductor (conductive wire) for operation in a first band. The circuit board is completely or partly contained within the helical conductor of the first radiating element and comprises a second radiating element for operation in a second band and a matching structure. The coaxial feed is electrically connected to the matching structure and the two radiating elements.

In an application of the dual-band antenna structure in a mobile communication device, the helical conductor of the first radiating element is operable with a wireless signal of the first band, such as signals of VHF or UHF, while the second radiating element arranged inside the first radiating element works with a signal of the second band, such as signals of GPS or GSM. Thus, the present invention features operation in two frequency bands. Further, since the circuit board of the present invention comprises a second radiating element that is formed by a metal trace connected to a central conductor of the coaxial feed and a matching structure that is formed by a matching metal trace connected to an outer conductor of the coaxial feed, input impedances of these two frequency bands are set around 50 ohms, and the performance of the antenna is enhanced. Further, the present invention provides a structure that is simple so that the manufacturing costs are reduced and the product size maintains small to comply with the current trend of being compact and light-weighted.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating a conventional dual-band antenna structure.

FIG. 2 is a Smith chart of input impedance of the conventional antenna of FIG. 1.

FIG. 3 is a schematic view illustrating another conventional dual-band antenna structure.

FIG. 4 is a schematic view illustrating a further conventional dual-band antenna structure.

FIGS. 5A and 5B are schematic views of feeds of the two conventional dual-band antennas.

FIG. 6 is a schematic view illustrating a mobile communication device in which the present invention is embodied.

FIG. 7 is a schematic view illustrating a dual-band antenna structure in accordance with the present invention.

FIGS. 8A and 8B are front side and rear side views of a circuit board of the dual-band antenna of the present invention.

FIG. 9 is a Smith chart of input impedance of the dual-band antenna in accordance with the present invention.

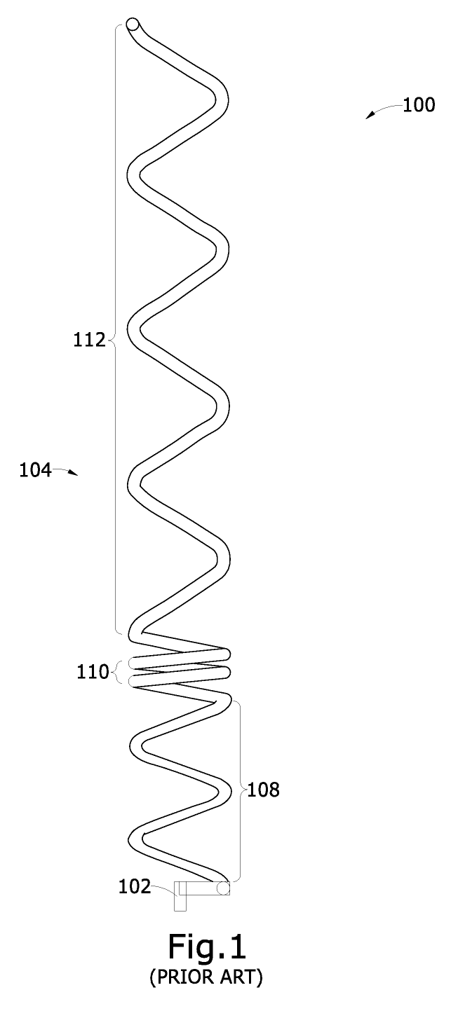

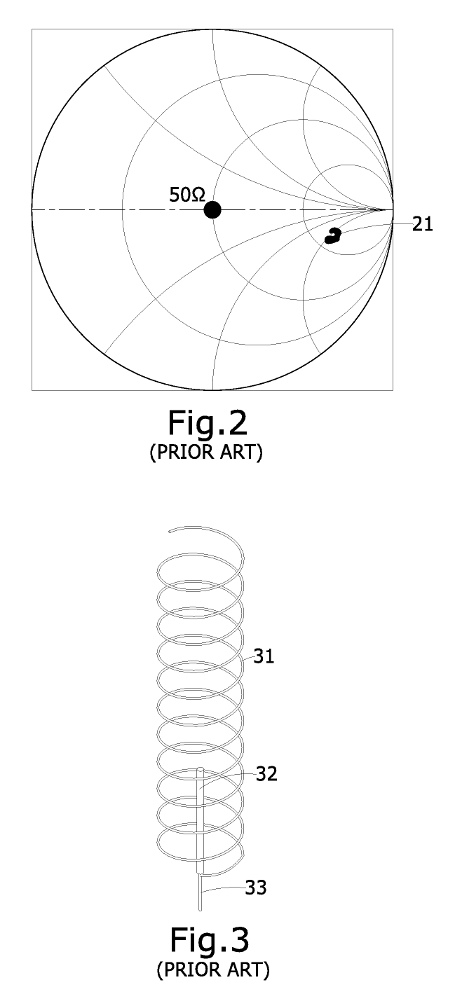

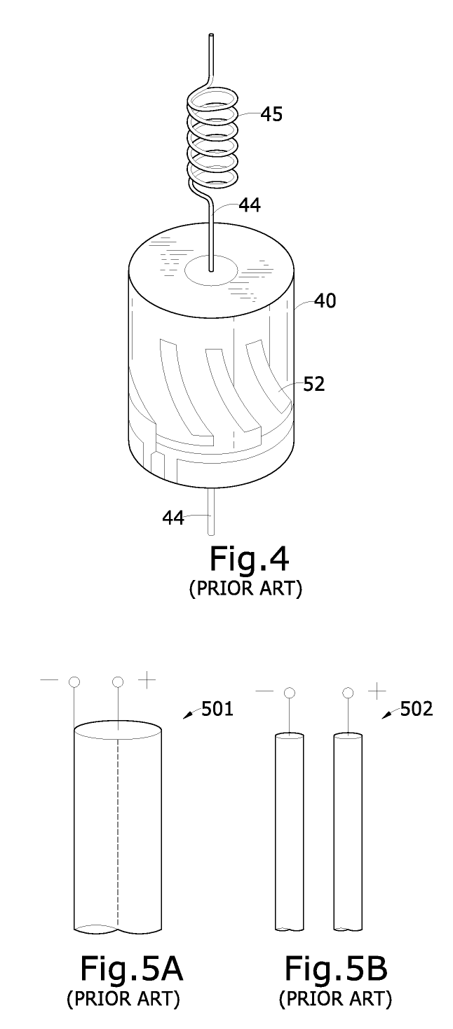

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

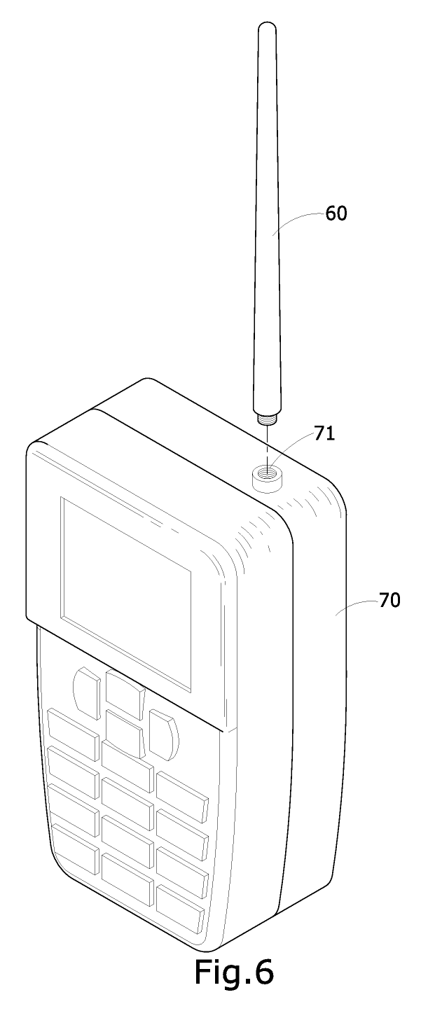

With reference to FIG. 6 first, an embodiment of the present invention is shown, which is a dual-band antenna 60 operable in VHF band and GPS band and mountable to a feed connector 71 of various mobile communication devices, generally designated at 70, such as a two-way radio, (as illustrated in FIG. 6).

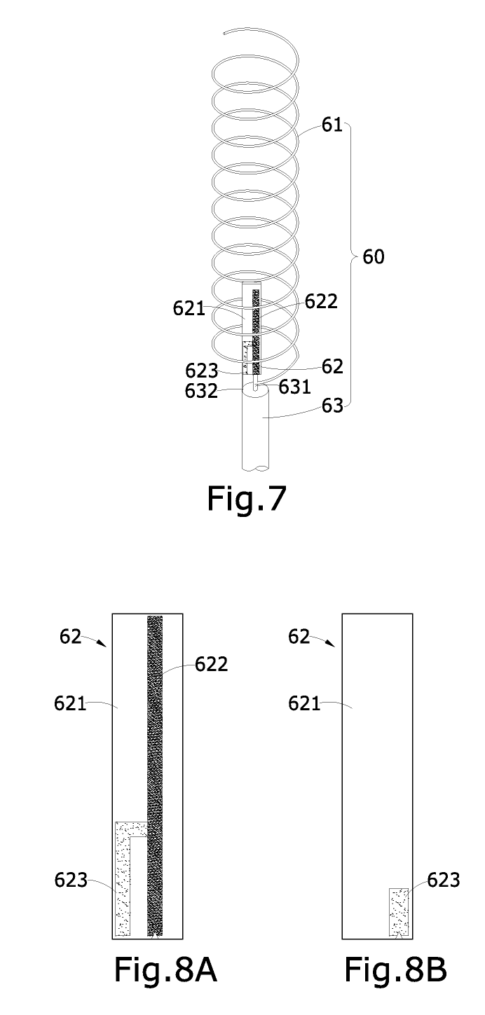

Also referring to FIGS. 7 and 8, the dual-band antenna 60 of the present invention generally comprises a first radiating element 61, a circuit board 62, and a coaxial feed 63. The first radiating element 61 comprises a long helical conductor for operation in a first band. The circuit board 62 is completely or partly received inside the helical conductor of the first radiating element 61 and comprises a second radiating element 621 for operation in a second band and a matching structure 622. The coaxial feed 63 is electrically connected to the matching structure 622 and the two radiating elements 61,621.

In the embodiment constructed as above, the first radiating element is connected to a central conductor 631 of the coaxial feed 63 with a lower end of the helical conductor. The second radiating element 621 of the circuit board 62 comprises a straight metal trace (namely presenting an I-shape, or being alternatively a T-shape or a multiple-turn S-shape) formed on the circuit board 62 (as shown in FIGS. 8A and 8B) and electrically connected to the central conductor 631 of the coaxial feed 63. The matching structure 622 of the circuit board 62 comprises a matching metal trace arranged beside the second radiating element 621 and connected to an outer conductor 632 of the coaxial feed 63.

The first radiating element 61 discussed above is not limited to operation in the VHF band and is also be operable in UHF band and low-band VHF band. The second radiating element 62 is not limited to operation in the GPS band and may also be operable in GSM (Global System for Mobile Communications) and Bluetooth™ bands.

The straight metal trace of the second radiating element 621 and the matching metal trace of the matching structure 622 are made of the same electrically conductive metal material. In the embodiment illustrated in FIG. 7, the straight metal trace of the second radiating element 621 and the matching metal trace of the matching structure 622 are formed as printed circuits on the circuit board 62.

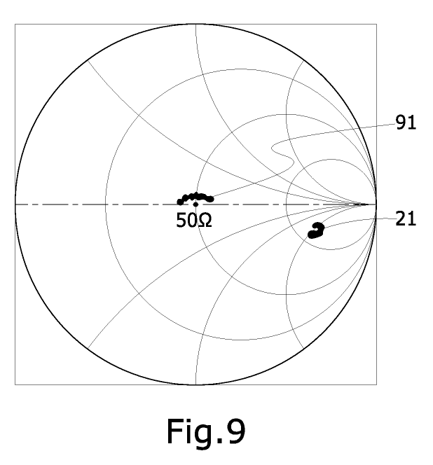

In an application of the dual-band antenna 60 described above in a mobile communication device 70, the helical conductor of the first radiating element 61 functions to receive and transmit signals in the VHF band, while the second radiating element 621 of the circuit board 62 arranged inside the helical conductor of the first antenna element 61 works to receive signals in the GPS band. Thus, the dual-band antenna 60 of the present invention is operable in both VHF and GPS bands. Further, since the circuit board 62 of the present invention comprises a second radiating element 621 that is connected to the central conductor 631 of the coaxial feed 63 and a matching structure 622 that is connected to the outer conductor 632 of the coaxial feed 63, the input impedances of these two frequency bands of the dual-band antenna 60 are set around 50 ohms (as indicated by reference numeral 91 of FIG. 9, which shows a significant difference from the input impedance indicated by reference numeral 21 for the conventional antenna structures), and thus the present invention helps enhancing the performance of the dual-band antenna. Further, as compared to the conventional antenna illustrated in FIG. 4, the present invention has a simple structure that reduces the manufacturing costs and provides a small size to thereby comply with the trend of being compact and light-weighted.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dual-band antenna, comprising a first radiating element, a circuit board, and a coaxial feed;
wherein the first radiating element comprises a long helical conductor for operation in a first frequency band;
wherein the circuit board is arranged, completely or partly, inside the helical conductor of the first radiating element and comprises a second radiating element for operation in a second band and a matching structure; and
wherein the coaxial feed is electrically connected to the matching structure and the radiating elements.

2. The dual-band antenna according to claim 1, wherein the first radiating element is connected to a central conductor of the coaxial feed with a lower end of the helical conductor; and
wherein the second radiating element of the circuit board comprises a first metal trace connected to the central conductor of the coaxial feed and the matching structure comprises a second metal trace arranged beside the second radiating element and connected to an outer conductor of the coaxial feed.

3. The dual-band antenna according to claim 1, wherein the first radiating element is operable with a signal of either a very high frequency (VHF) band, an ultra-high frequency (UHF) band, or a low-band VHF band.

4. The dual-band antenna according to claim 1, wherein the second radiating element is operable with a signal of either a global positioning system (GPS), Global System for Mobile Communications (GSM), or Bluetooth™ bands.

5. The dual-band antenna according to claim 2, wherein the first metal trace of the second radiating element and the second metal trace of the matching structure are made of the same electrically-conductive metal material.

6. The dual-band antenna according to claim 2, wherein the metal traces of the second radiating element and the matching structure are printed circuits formed on the circuit board.

7. The dual-band antenna according to claim 2, wherein the metal trace of the second radiating element comprises either an I-shape, a T-shape, or an S-shape.
